(19) United States
(12) Patent Application Publication
(10) Pub. No.: US 2002/0032533 A1
(43) Pub. Date: Mar. 14, 2002

(54) Continuous measurement and control method for the tension and/or running of adjacent yarns in knitting machines

(76) Inventor: Fulvio Sangiacomo, Brescia (IT)

Correspondence Address: McGLEW AND TUTTLE, P.C., SCARBOROUGH STATION, SCARBOROUGH, NY, 10510-0827, US

(21) Appl. No.: 09/881,531

(22) Filed: Jun. 14, 2001

(30) Foreign Application Priority Data
Jun. 27, 2000 (IT) BS2000A000060

(51) Int. Cl. G01L 1/00; G01L 3/00; G01L 5/00; G06F 19/00

(52) U.S. Cl. 702/42

(57) ABSTRACT

The invention concerns an automatic and continuous measurement and control method of the tension and/or running of the yarns fed into knitting machines. It consists of permanently placing, along the route of each yarn towards the machine a device 15 for measuring the tension and/or running of the yarn, of connecting the devices to a management computer 16, programmed to recognise, display and process the reading data coming from each device and of the issuing by the computer of correction signals for the tension and/or running values of every yarn at every machine supply station and/or of the knitting in progress, when these values go beyond the prefixed limits.

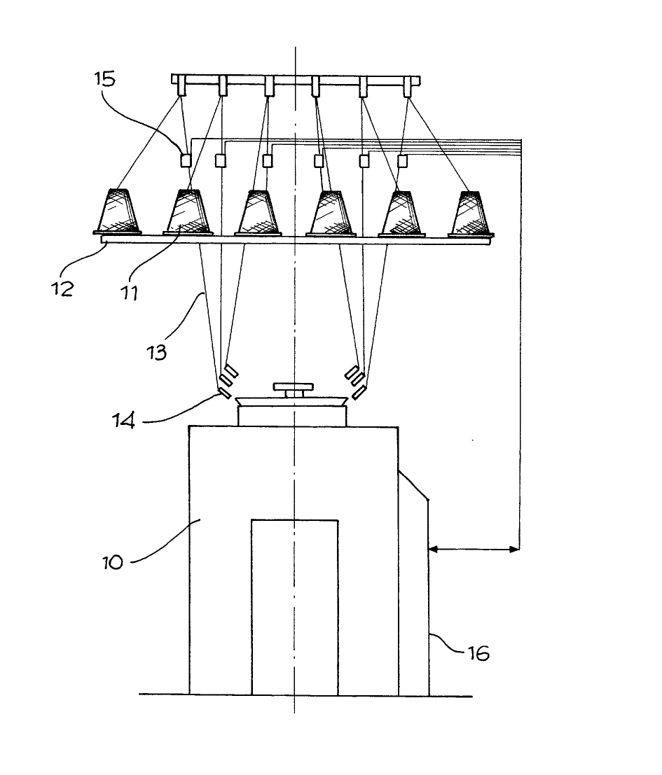

### FIELD OF THE INVENTION

This invention concerns the knitting machine sector, especially circular knitwear and hosiery machines and particularly for controlling the tension and/or running of the yarns fed into these machines.

### STATE OF THE ART

Usually, the yarns fed into and knitted in machines for knitwear and hosiery come from reels located on gantry or better a reel support trellis. The unwinding of the yarns may be different from reel to reel or from the same reel and cause variations in the tension and/or running of the yarns directed to the machine. On the other hand, it is well known that for successful and uniform knitting, all the yarns have to be supplied with their tension and/or running as regular and constant as possible at every machine supply station. For this reason there is often the need in knitwear and hosiery machines to measure the tension and/or running of the yarns to be knitted. For this operation, devices are now available which are used manually by approaching them to each yarn to check their tension and/or running, to check the uniformity of yarn supply at the various feed stations and to be able to make variations necessary to obtain a good knitting quality. Nevertheless, the regularity of the control and the reliability of the information and the interventions necessary depend exclusively on how expert the operator is as the machines considered do not currently have their own means to manage themselves in reply to the variations in the tension and/or running of the yarns in arrival.

### REVELATION OF THE INVENTION

One purpose of this invention is to obviate the limitations and the disadvantages of the known technique with a continuous reading and control method of the tension and/or running of the yarns fed into knitting machines, reducing the manual intervention of the operators and automating the corrections to be made to the supply of the yarns and/or the knitting being performed to restore optimum conditions for correct knitting formation.

Another purpose of this invention is to offer circular machines for knitwear and hosiery equipped so as to automatically and continuously read the information concerning the tension and/or running of each yarn to be knitted, to automatically manage the data read and to intervene in reply and according to the measurements to correct any variations beyond certain limits for the tension and/or running of the yarns and/or the dimensional characteristics of the knitting in progress.

### DETAILED DESCRIPTION OF THE INVENTION

The said purposes are reached with a measurement and control method which will be described here as follows by making reference to the enclosed schematic and purely indicative drawing.

This drawing generally represents a circular machine 10 with reels 11 supported on a reel-support trellis 12 from each of which a yarn 13 is unwound to be fed into the machine through the respective yarn-fingers 14. Along the route of each yarn, and close to the machine a measurement device 15 is fitted for the tension and/or running of the yarn itself. The device 15 can be of the type and operation as those known but one which remains stationary and permanently in the control position with respect to the yarn.

The devices 15 fitted to the machine are connected to a management computer 16, suitably programmed, which could be the same computer onboard the machine when equipped with one. The computer 16 is enabled to recognise the reading data from each single control device 15, to display the data on a display for the visual verification also by the machine operator and to process it according to the program and to send signals to intervention devices to restore the tension and/or running values of each yarn when these leave the pre-established limits.

The computer can also be enabled to rapidly stop the machine if the tension and/or running values do not return within the pre-fixed limit values in spite of the corrective interventions.

In other terms, the devices 15 fitted permanently to the machine 10 automatically read the tension and/or running of each yarn with the reading data sent to and displayed on a computer. This permits the real time verification of the uniformity of the tension and/or running of the yarns directly at each station supplying the machine and intervention to restore this uniformity, if and when it should not be present.

The computer can be programmed for self-learning, by memorising the tension and/or running values of each fed in yarn during the execution of the first correctly knitted item. In this way, the computer is able to check the tension and/or running at any moment during the knitting of every successive item by making the machine respect the prefixed values, with the certain advantage of being able to obtain items with the same knitting characteristics and with always uniform and constant shapes.

1. An automatic and continuous control and measurement method for the tension and/or running of the yarns fed into knitting machines, characterised by the permanent emplacement, along the route of each yarn towards the machine of a device 15, for measuring the tension and/or running of the yarn itself, connection of the measurement devices to a management computer 16, programmed to recognise and process the reading data from each device and the issue by the computer of correction signals for the tension and/or running values of each yarn at every feed station of the machine and/or of the knitting in progress when these values leave the prefixed limits.

2. A method according to claim 1 in which the management computer can be programmed for self-learning through the memorisation of the tension and/or running data of every yarn supplied during the execution of a correctly executed sample item.

3. A circular machine for knitwear and hosiery including the reels supported on a reel support trellis from which a yarn is unwound to feed the machine through their respective yarn-fingers, characterised by a tension and/or running measurement device for each yarn, permanently fitted along the route of the yarn towards the machine and by a computer for receiving and managing the information arriving from the measurement devices for the retroactive control of the machine supply yarns.

4. A circular machine for knitwear and hosiery according to claim 3 in which the computer managing the information from the measurement and control devices is a management computer of the circular machine, foreseen on board.
